(19) United States
(12) Patent Application Publication
(10) Pub. No.: US 2006/0157192 A1
(43) Pub. Date: Jul. 20, 2006

(54) Apparatus and method for manufacturing laminated substrate

(75) Inventors: Joji Hasegawa, Kasugai (JP); Yoshimasa Miyajima, Kasugai (JP); Takanori Muramoto, Kasugai (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: FUJITSU LIMITED, Kawasaki (JP)

(21) Appl. No.: 11/146,095

(22) Filed: Jun. 7, 2005

(30) Foreign Application Priority Data
Jan. 19, 2005 (JP) 2005-011197

(51) Int. Cl. B32B 37/00

(52) U.S. Cl. 156/273.1; 156/285; 156/358; 156/556

(57) ABSTRACT

A laminated substrate manufacturing device for eliminating deformation of substrates during a period between when the substrates undergo a conveying process and an attracting process before the substrates are laminated. The laminated substrate manufacturing device includes two holding plates arranged in a processing chamber. Each holding plate includes vacuum pads for attracting a corresponding substrate. A controller controls an attraction device provided for each holding plate so that the holding plate sequentially attracts the corresponding substrate from a central portion to the peripheral portion of the substrate.

### CROSS-REFERENCE TO RELATED APPLICATIONS

This application is based upon and claims the benefit of priority from prior Japanese Patent Application No. 2005-011197, filed on Jan. 19, 2005, the entire contents of which are incorporated herein by reference.

### BACKGROUND OF THE INVENTION

The present invention relates to an apparatus and method for manufacturing laminated substrates (panels) in which two substrates are laminated to each other, and more particularly, to an apparatus and a method for manufacturing a panel for a flat panel display such as a liquid crystal display (LCD).

Recently, demands for larger, thinner, and lower cost are increasing for flat panel displays such as liquid crystal displays. An apparatus for laminating two substrates to manufacture a flat display panel is also required to be larger while improving productivity.

A liquid crystal panel is manufactured, for example, by arranging an array substrate (TFT substrate), in which TFTs (thin film transistors) are formed in a matrix, and a color filter substrate (CF substrate), in which color filters (red, green, blue) and a light shielding film are formed, facing each other with an extremely narrow gap (approximately a few micrometers) in between, and filling the gap between the two substrates with a liquid crystal. The light shielding film is used to obtain high contrast or to shield the TFTs and prevent the occurrence of light leakage current. The TFT substrate and the CF substrate are laminated with a seal (adhesive) that contains, for example, a thermosetting resin.

In the process for manufacturing the liquid crystal panel, the liquid crystal is filled between the TFT substrate and the CF substrate. In a general liquid crystal-dropping process, a frame of the seal is formed on the periphery of the TFT substrate. A certain amount of liquid crystal is dropped onto the substrate surface defined in the frame of the seal. The TFT substrate and the CF substrate are laminated in a vacuum environment to seal the liquid crystal between the substrates.

The two substrates are laminated by a pressing apparatus serving as a laminating device in the substrate pressurizing process. The pressing apparatus includes an upper holding plate and a lower holding plate arranged facing each other in a processing chamber. Each holding plate holds a substrate. The two substrates are laminated with an even gap by moving the two holding plates toward each other while maintaining the holding plates precisely parallel to each other.

As shown in FIGS. 1 to 3, a table 1 is arranged in the processing chamber in a conventional pressing apparatus. Lower holding members 2 are movable in upward and downward directions so as to move away from or move towards the table 1. A pressing plate 3 is arranged above the lower holding members 2 and is movable in upward and downward directions.

Robot hands 4a, 4b convey an upper substrate W1 and a lower substrate W2 into the processing chamber and a laminated substrate W3 out of the processing chamber. Shutters 5, normally positioned outside the processing chamber, enter the processing chamber when the upper substrate W1 is conveyed into the processing chamber. The shutters 5 aid in attracting the upper substrate W1 to the pressing plate 3.

The conveying operation of the substrates W1 and W2 will now be discussed. First, the robot hand 4a attracting and holding an upper surface (non-laminating surface) of the upper substrate W1 enters the processing chamber. The shutters 5 then close and enter the processing chamber, as shown in FIG. 2.

As show in FIG. 3, the robot hand 4a is then lowered. This places the peripheral portion of the substrate W1 on the shutters 5. Further, the central portion of the substrate W1 is attracted to an upper holding member (not shown). The robot hand 4a then releases the substrate W1 and moves out of the processing chamber. When moving out of the processing chamber, the robot hand 4a conveys the substrate W3, which was laminated in the previous cycle and which is supported on the lower holding members 2, out of the processing chamber.

The upper holding member is then raised and the substrate W1 is attracted to the pressing plate 3. The substrate W2 held by the robot hand 4b is conveyed into the processing chamber and attracted to the table 1.

After the robot hand 4b is moved out of the processing chamber, the processing chamber is tightly sealed. Then, the pressing plate 3 is lowered to press and laminate the substrates W1 and W2 with the table 1.

Japanese Laid-Open Patent Publication No. 2002-229044 describes a first prior art example of a substrate laminating apparatus.

Japanese Laid-Open Patent Publication No. 9-80404 describes an attraction stage including a plurality of suction grooves. The substrate is attracted to the attraction stage by attracting the substrate with the suction grooves with a time difference therebetween. Further, Japanese Laid-Open Patent Publication Nos. 2001-353682, 8-181054, and 2002-62822 describe similar substrate attraction apparatuses.

### SUMMARY OF THE INVENTION

The substrate laminating device of the prior art holds the substrates W1 and W2 on the pressing plate 3 and the table 1 by means of either a vacuum chuck (vacuum attraction) or an electrostatic chuck (electrostatic attraction).

When laminating the substrates W1 and W2 in a depressurized processing chamber, the vacuum chuck stops functioning to hold the substrates. In this case, the substrates W1 and W2 are held by the electrostatic chuck. The electrostatic chuck attracts the glass substrate using Coulomb force generated when voltage is applied to electrodes arranged on the table 1 and the pressing plate 3 and to an electrically conductive film formed on the glass substrate.

During transportation of the substrate W1 with the robot hand 4a, the substrate W1 is deformed or flexed due to its own weight. The robot hand 4a is also deformed or flexed at its distal portion due to its own weight, which in turn further deforms the substrate W1. This deformation has increased in recent substrates, which are larger and thinner.

When the substrate W1 deforms, the attraction of the substrate W1 to the pressing plate 3 becomes unstable. In addition, when the substrate W1 is attracted to the pressing plate 3 in a deformed state, the substrate W1 may become displaced with respect to the pressing plate 3 or separated from the pressing plate 3 when the processing chamber is depressurized.

When the substrate W1 is electrostatically attracted to the pressing plate 3 in a deformed state, glow discharge tends to occur when depressurizing the processing chamber. The glow discharge may damage circuits and TFT elements on the substrate.

The technique described in Japanese Laid-Open Patent Publication No. 9-80404 prevents attraction failures of the glass substrate even if the glass substrate flexes or the existence of foreign materials. However, the publication does not describe a structure for attracting the substrate while correcting the deformation of the substrate. Further, suction grooves must be arranged on the attraction stage, and pin chucks for supporting the substrate must be arranged in the attraction grooves. The structure of the attraction stage is thus complicated. If the pin chucks have an insufficient machining accuracy, the height of the pin chucks may become uneven and deform the substrate.

In the apparatuses described in Japanese Laid-Open Patent Publication Nos. 2001-353682, 8-181054, and 2002-62822, deformation of the attracted substrate is not corrected.

Accordingly, it is an object of the present invention to provide a laminated substrate manufacturing apparatus that prevents deformation of the substrate when conveying the substrate before performing lamination to improve the yield of the laminated substrate.

One aspect of the present invention is a manufacturing device for laminating substrates, each substrate including central and peripheral portions. The manufacturing device includes a processing chamber. Holding plates, each arranged in the processing chamber, respectively hold the substrates and laminate the substrates to each other. An attraction device, arranged on at least one of the holding plates, attracts a corresponding substrate. A controller controls the attraction device so that the attraction device sequentially attracts the corresponding substrate from the central portion to the peripheral portion.

Another aspect of the present invention is a method for laminating substrates, each substrate including central and intermediate portions, with the intermediate portion located on the outer side of the central portion, and a peripheral portion located on the outer side of the intermediate portion. The method includes attracting each substrate from the central portion to the intermediate portion and then the peripheral portion, and laminating the attracted substrates.

Other aspects and advantages of the present invention will become apparent from the following description, taken in conjunction with the accompanying drawings, illustrating by way of example the principles of the invention.

### BRIEF DESCRIPTION OF THE DRAWINGS

The invention, together with objects and advantages thereof, may best be understood by reference to the following description of the presently preferred embodiments together with the accompanying drawings in which:

FIGS. 1 to 3 are schematic diagrams showing the operation of a laminated substrate manufacturing apparatus in the prior art;

FIG. 4 is a schematic diagram showing a laminated substrate manufacturing apparatus according to a first embodiment of the present invention;

FIG. 5 is a cross-sectional view of a pressing plate and an upper holding device of the first embodiment;

FIG. 6 is a side view showing the upper holding device and a first robot hand;

FIG. 7 is a bottom view showing the upper holding device and the first robot hand;

FIG. 8 is a side view showing the upper holding device and the pressing plate;

FIG. 9 is a bottom view showing the upper holding device and the pressing plate;

FIG. 10 is a plan view showing the layout of electrostatic blocks in the pressing plate;

FIG. 11 is a plan view of a table and a lower holding device;

FIGS. 12(a), 12(b), 12(c) are cross-sectional views of an attraction pad;

FIGS. 13 to 24 are schematic views showing the operation of the laminated substrate manufacturing apparatus of FIG. 4;

FIG. 25 is a side view of an upper holding device according to a second embodiment of the present invention; and

FIG. 26 is a bottom view of the upper holding device of the second embodiment.

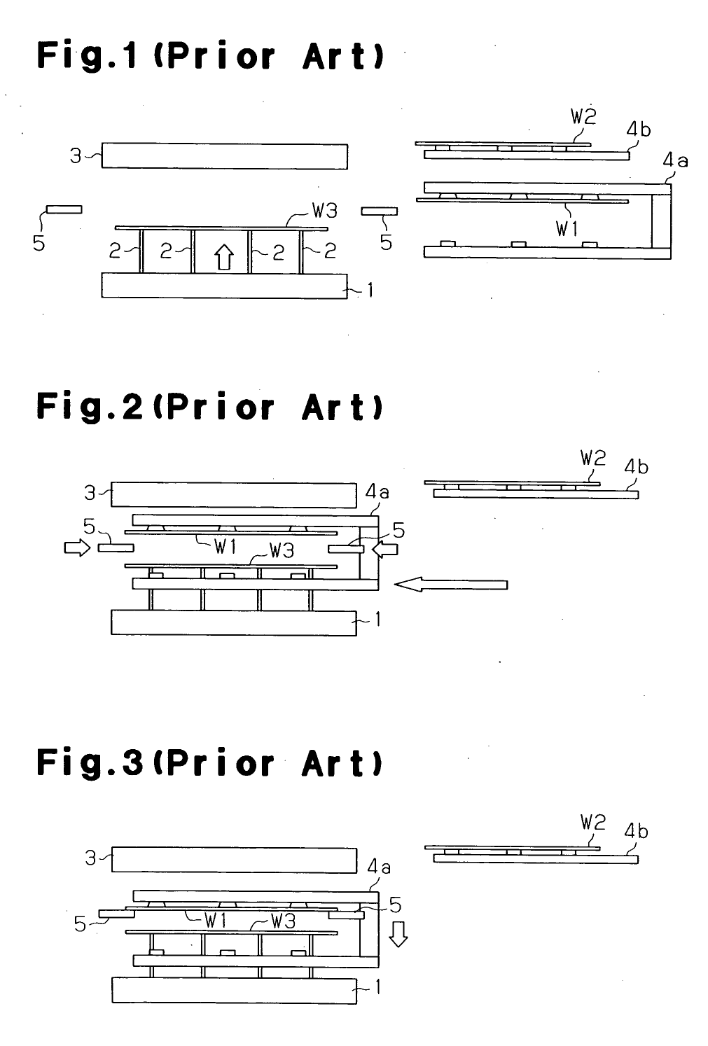

### DETAILED DESCRIPTION OF THE PREFERRED EMBODIMENTS

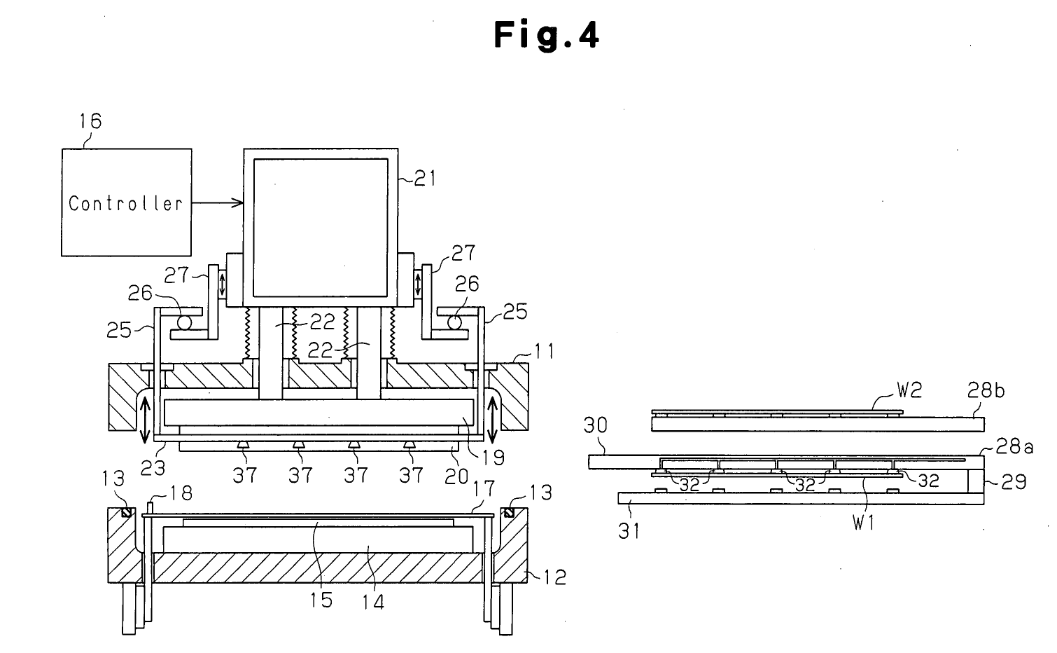

FIG. 4 shows a laminated substrate manufacturing apparatus (pressing apparatus) according to a first embodiment of the present invention. The laminated substrate manufacturing apparatus is configured by an upper shell 11 and a lower shell 12. The upper shell 11 is lowered and raised with respect to the lower shell 12 by means of a driving mechanism such as an actuator (not shown).

When the upper shell 11 is lowered until its opening edge contacts the opening edge of the lower shell 12, the upper shell 11 and the lower shell 12 become sealed and define a processing chamber (vacuum chamber).

A seal 13 is attached on an upper surface of the opening edge of the lower shell 12 that contacts the opening edge of the upper shell 11. The seal 13 ensures hermetic sealing of the vacuum chamber.

A table (second holding plate) 15 including a lower mass 14 is arranged in the lower shell 12. The table 15 includes an attraction device (vacuum chuck and electrostatic chuck) A controller 16 controls the attraction device of the table 15.

A lower holding device 17 is supported in the lower shell 12 so that it may be raised and lowered by a driving device (not shown). The lower holding device 17 has the form of a fence (ladder-shaped) and includes a plurality of support rods, each having ends connected to a connecting frame. Accommodating grooves are formed in the table 15 for accommodating each support rod so that the support rod is not exposed from the upper surface of the table 15 when the lower holding device 17 is lowered to the lowermost position.

A deformation prevention piece 18, projecting upward, is formed on one side of the frame configuring the lower holding device 17. The deformation prevention piece 18 supports a distal end of a first robot hand 28a, and prevents the first robot hand 28a from drooping, or deforming downward, due to its own weight.

An upper mass (surface plate) 19 is supported above the table 15. A pressing plate 20 (first holding plate) is attached to a lower surface of the upper mass 19. The upper mass 19 is supported by suspension shafts 22. The suspension shafts 22 are coupled to a driving device 21, which includes a motor, above the upper shell 11. The upper mass 19, which is controlled by the driving device 21, is lowered and raised under the upper shell 11. The pressing plate 20 is lowered and raised integrally with the upper mass 19.

The pressing plate 20 includes an attraction device (vacuum chuck and electrostatic chuck) for attracting the upper surface (non-laminating surface) of a substrate W1. The controller 16 controls the attraction device of the pressing plate 20.

An upper holding device 23 is arranged below the pressing plate 20. In the same manner as the lower holding device 17, the upper holding device 23 has the form of a fence and includes a plurality of support rods, each having ends connected to a connecting frame. A plurality of attraction pads 37 opening in the downward direction are arranged on each support rod. The plurality of attraction pads 37 attract the upper surface of the substrate W1.

Support shafts 25, extending upward through the upper shell 11, are attached to opposite sides of the upper holding device 23. The upper ends of the support shaft 25 are supported by lifting shafts 27 in a suspending manner through flexible couplings 26. The driving device 21 controls the raising and lowering of the lifting shaft 27.

The driving device 21 controls the lowering and raising of the upper holding device 23. The flexible couplings 26 support the upper holding device 23 movably in the horizontal direction with respect to the lifting shafts 27. The flexible couplings 26 tolerate relative movement in the horizontal direction between the pressing plate 20 and the upper holding device 23 when performing an alignment process to correct displacement in the horizontal direction of the substrate W1 that is held by the pressing plate 20.

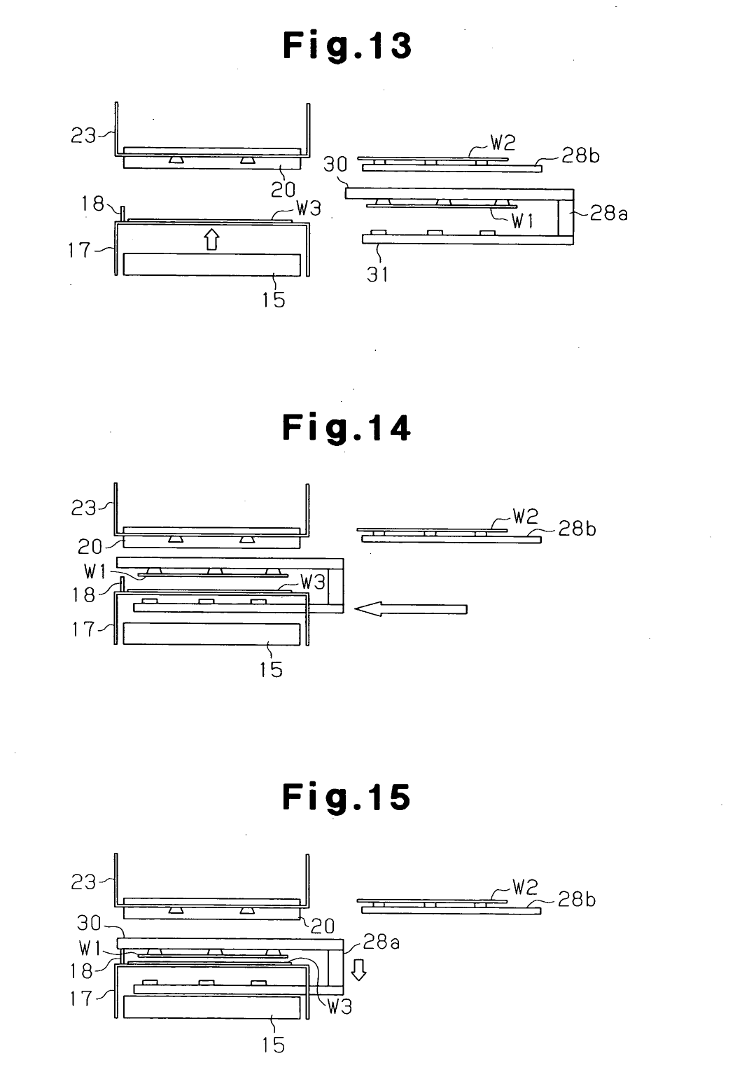

The first robot hand 28a and the second robot hand 28b convey the substrate W1 and the substrate W2, respectively, to a position between the lower holding device 17 and the upper holding device 23. The first robot hand 28a includes a main frame 29 located on the basal side. Further, the first robot hand 28a includes upper arms 30 and lower arms 31. The upper and lower arms 30 and 31 extend parallel to each other and are coupled to the main frame 29. Attraction pads 32 for attracting the upper surface 1b of the substrate W1 are formed on the upper arms 30. The lower arms 31 support the laminated substrate W3 (refer to FIG. 13).

The upper arms 30 are longer than the lower arms 31. When advancing into the processing chamber, the distal end of the upper arm 30 enters the movement path of the deformation prevention piece 18 of the lower holding device 17.

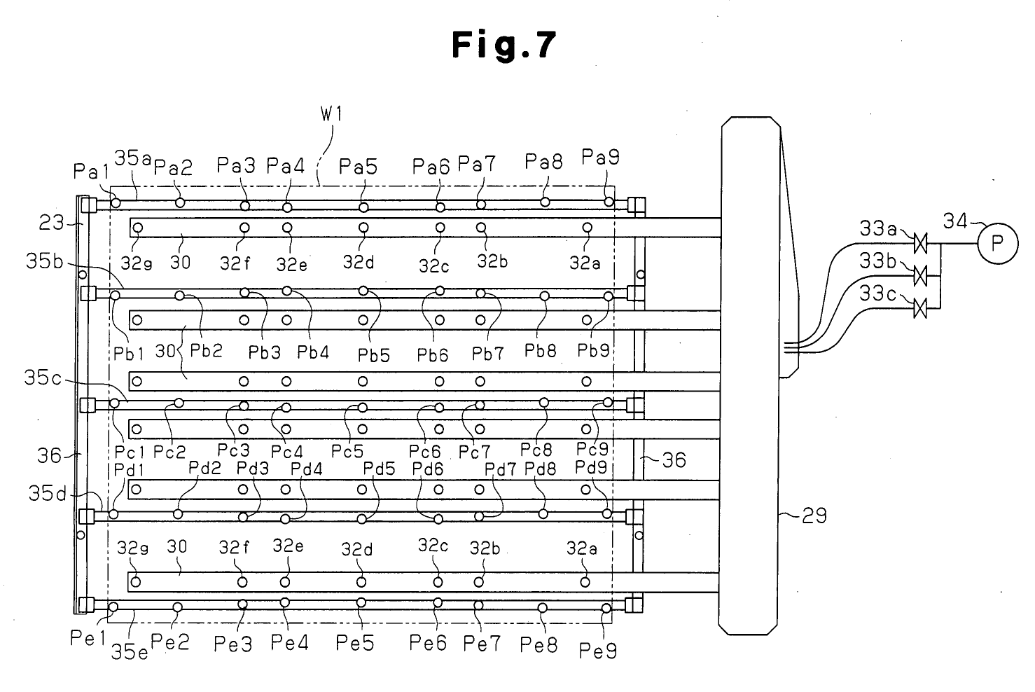

FIGS. 6 and 7 show the positional relationship between the upper arms 30 of the first robot hand 28a and the upper holding device 23 when the substrate W1 is conveyed into the processing chamber. Six upper arms 30 are extended parallel to each other from the main frame 29. Seven attraction pads 32a to 32g are arranged on each upper arm 30.

Three tube lines, supplying vacuum pressure and extending from the main frame 29, are arranged in each upper arm 30. Each tube line is connected to a vacuum pressure source 34 through three valves 33a to 33c arranged outside the main frame 29. The controller 16 controls the opening and closing of the valves 33a to 33c. An attraction control device includes the controller 16 and the valves 33a to 33c.

The suction force (vacuum pressure) of the three attraction pads 32c, 32d, and 32e positioned in the middle of each upper arm 30 is adjusted by the valve 33c. The suction force of the two attraction pads 32b and 32f positioned at the outer sides of the attraction pads 32c, 32d, and 32e is adjusted by the valve 33b. The suction force of the two attraction pads 32a and 32g positioned near the two ends of each upper arm 30 is adjusted by the valve 33a. This control is common to all six upper arms 30.

Prior to conveying the substrate W1 into the processing chamber, the substrate W1 is attracted to the upper arms 30. More specifically, the valve 33c is first opened, and the attraction pads 32c, 32d and 32e of each upper arm 30 attract the longitudinally central portion of the substrate W1. Next, the valve 33b is opened, and the attraction pads 32b, 32f of each upper arm 30 attract the substrate W1. Finally, the valve 33a is opened, and the attraction pads 32a, 32g attract the substrate W1.

Such control prevents the substrate W1 from deforming when the upper arms 30 attract the substrate W1. The order of opening and closing of the valves 33a to 33c may be appropriately changed in accordance with the state of deformation of the substrate W1 before the upper arms 30 attract the substrate W1.

As shown in FIG. 7, the upper holding device 23 includes five support rods 35, the ends of which are coupled to two coupling frames 36. Nine attraction pads 37 are arranged on each support rod 35. More specifically, the support rod 35a includes attraction pads Pa1 to Pa9. The support rod 35b includes attraction pads Pb1 to Pb9. The support rod 35c includes attraction pads Pc1 to Pc9. The support rod 35d includes attraction pads Pd1 to Pd9. The support rod 35e includes attraction pads Pe1 to Pe9.

Each support rod 35 includes three tube lines, extending from the coupling frame 36, for supplying vacuum pressure. Each tube line is connected to a vacuum pressure source 39 through three valves 38a to 38c arranged outside the coupling frame 36. The controller 16 controls the opening and closing of the valves 38a to 38c. An attraction control device includes the controller 16 and the valves 38a to 38c.

The suction force (vacuum pressure) of the attraction pads Pa1 to Pa9 in the support rod 35a is adjusted by the valve 38a.

The suction force of the attraction pads Pb1 and Pb9 in the support rod 35b is adjusted by the valve 38a. The suction force of the attractions pads Pb2, Pb3, Pb7, and Pb8 is adjusted by the valve 38b. The suction force of the attraction pads Pb4 to Pb6 is adjusted by the valve 38c.

The suction force of the attraction pads Pc1 and Pc9 in the support rod 35c is adjusted by the valve 38a. The suction force of the attractions pads Pc2, Pc3, Pc7, and Pc8 is adjusted by the valve 38b. The suction force of the attraction pads Pc4 to Pc6 is adjusted by the valve 38c.

The suction force of the attraction pads Pd1 and Pd9 in the support rod 35d is adjusted by the valve 38a. The suction force of the attractions pads Pd2, Pd3, Pd7, and Pd8 is adjusted by the valve 38b. The suction force of the attraction pads Pd4 to Pd6 is adjusted by the valve 38c.

The suction force of the attraction pads Pe1 to Pe9 in the support rod 35e is adjusted by the valve 38a.

In the first embodiment, the attraction pads Pb4 to Pb6, Pc4 to Pc6, and Pd4 to Pd6 arranged at the central portion of the upper holding device 23 are referred to as a central zone pad group. The attractions pads Pb2, Pb3, Pb7, Pb8, Pd2, Pd3, Pd7, and pd8 arranged so as to surround the central zone pad group are referred to as an intermediate zone pad group. The attraction pads Pa1 to Pa9, Pb1, Pb9, Pc1, Pc9, Pd1, Pd9, and Pe1 to Pe9 arranged near the peripheral portion of the upper holding device 23 are referred to as a peripheral zone pad group. The central zone pad group, the intermediate zone pad group, and the peripheral zone pad group are arranged substantially concentrically.

The operation of the valves 38a to 38c when attracting the upper holding device 23 the substrate W1 will now be described.

The controller 16 first opens the valve 38c to attract the central portion of the substrate W1 with the attraction pads Pb4 to Pb6, Pc4 to Pc6, and Pd4 to Pd6 of each support rod 35b to 35d.

The controller 16 then opens the valve 38b to attract the portion on the outer sides of the central portion of the substrate W1 (intermediate portion), that is, the portion surrounding the portion of the substrate W1 previously attracted by operating the valve 38c, with the attraction pads Pb2, Pb3, Pb7, Pb8, Pc2, Pc3, Pc7, Pc8, Pd2, Pd3, Pd7, and Pd8 of each support rod 35b to 35d.

The controller 16 finally opens the valve 38a to attract the peripheral portion of the substrate with the attraction pads Pb1, Pb9, Pc1, Pc9, Pd1 and Pd9 of each support rod 35b to 35d and with the attraction pads Pa1 to Pa9 and Pe1 to Pe9 of each support rod 35a and 35e.

Such controlled vacuum attraction prevents the substrate W1 from deforming when the upper holding device 23 attracts the substrate W1. The deformation of the substrate W1 is corrected (eliminated) when transferring the substrate W1 from the upper arms 30 to the upper holding device 23 even if the substrate W1 is attracted to the upper arms 30 in a deformed state.

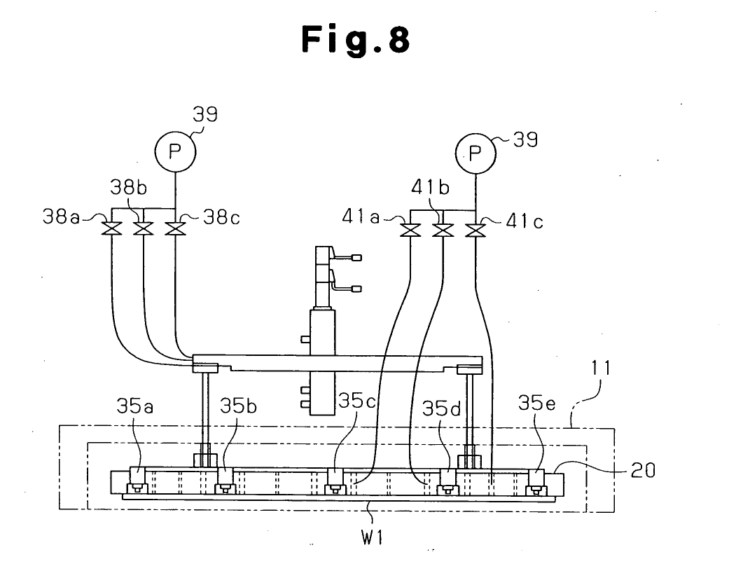

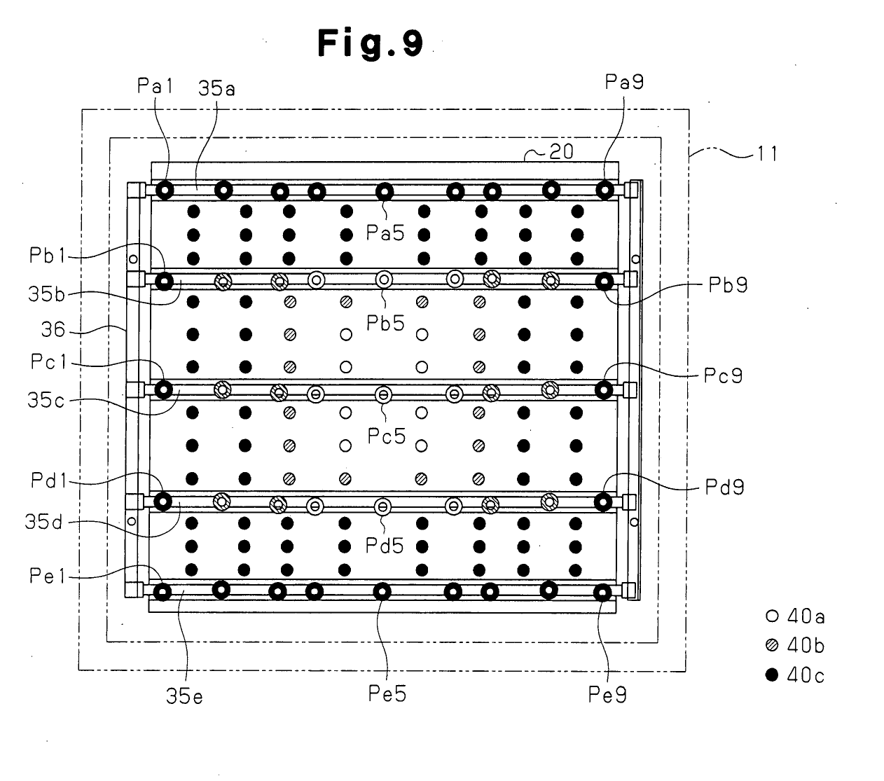

FIG. 8 and FIG. 9 show the positional relationship between the support rods 35a to 35e of the upper holding device 23 and a plurality of attraction holes 40a to 40c formed in the pressing plate 20. Three rows, each including eight attraction holes, are arranged between and parallel to two adjacent support rods 35a to 35e. The attraction holes 40a to 40c are divided into a first group of attraction holes 40a, a second group of attraction holes 40b, and a third group of attraction holes 40c.

The first group of attraction holes 40a is arranged at the central portion of the pressing plate 20 and faces the central portion of the substrate W1. The suction force of the first group of attraction holes 40a is adjusted by a valve 41a shown in FIG. 8. The second group of attraction holes 40b is arranged on the outer side of the first group of attraction holes 40a. The suction force of the second group of attraction holes 40b is adjusted by a valve 41b. The third group of attraction holes 40c is arranged on the peripheral portion of the pressing plate 20 and faces the peripheral portion of the substrate W1. The suction force of the third group of attraction holes 40c is adjusted by a valve 41c.

The controller 16 controls the opening and closing of the valves 41a to 41c. The pressing plate 20 sequentially attracts the substrate W1 from the central portion towards the peripheral portion by opening the valves in the order of valve 41a, valve 41b, and valve 41c. Such controlled vacuum attraction prevents the substrate W1 from deforming when the pressing plate 20 vacuum attracts the substrate W1. The deformation of the substrate W1 is corrected when transferring the substrate W1 from the upper holding device 23 to the pressing plate 20 even if the substrate W1 is attracted to the upper holding device 23 in a deformed state.

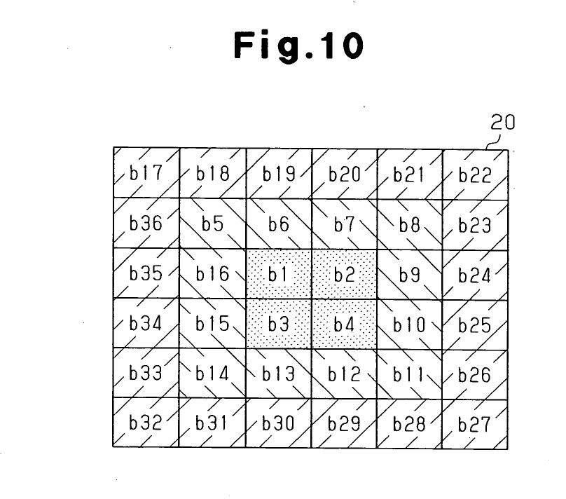

As shown in FIG. 10, the electrostatic chuck is arranged on the lower surface of the pressing plate 20. The electrostatic chuck includes a number of electrostatic blocks b1 to b36.

In the first embodiment, the four electrostatic blocks b1 to b4 arranged at the central portion of the pressing plate 20 is referred to as a central zone block group. The twelve electrostatic blocks b5 to b16 arranged so as to surround the electrostatic blocks b1 to b4 are referred to as an intermediate zone block group. The electrostatic blocks b17 to b36 arranged on the peripheral portion of the pressing plate 20 are referred to as a peripheral zone block group. The central zone block group, the intermediate zone block group, and the peripheral zone block group are arranged in a substantially concentric manner.

The controller 16 controls the application of voltage to each of the electrostatic blocks b1 to b36. When the pressing plate 20 electrostatically attracts the substrate W1, the controller 16 first applies voltage to the electrostatic blocks b1 to b4 to electrostatically attract the central portion of the substrate W1. The controller 16 then applies voltage to the electrostatic blocks b5 to b16 to electrostatically attract the intermediate portion of the substrate W1. Finally, the controller 16 applies voltage to the twenty electrostatic blocks b17 to b36 to electrostatically attract the peripheral portion of the substrate W1.

Such controlled electrostatic attraction electrostatically attracts the substrate W1 to the pressing plate 20 without deforming the substrate W1. The deformation of the substrate W1 is corrected when switching from vacuum attraction to electrostatic attraction even if the substrate W1 is electrostatically attracted to the pressing plate 20 in a deformed state.

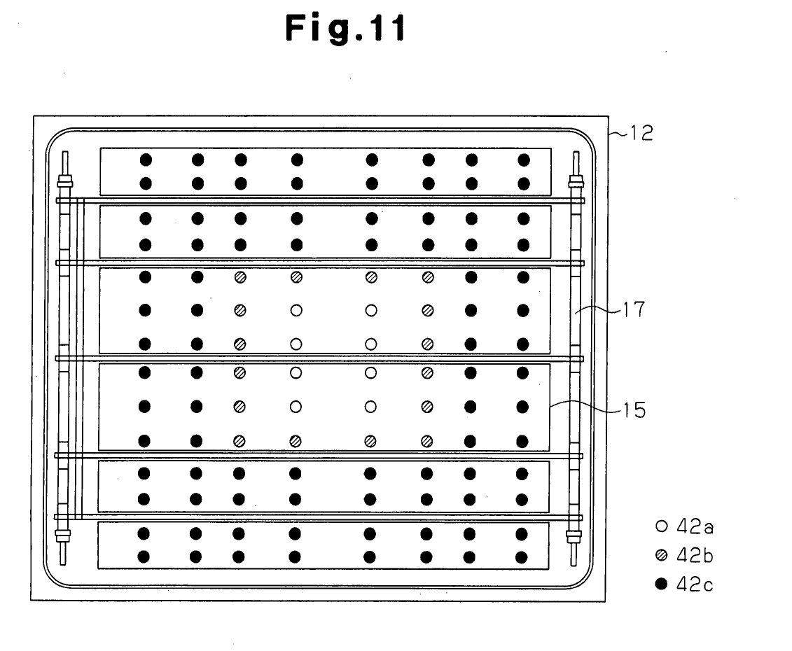

As shown in FIG. 11, the vacuum chuck of the table 15 includes a plurality of attraction holes 42a to 42c for vacuum attracting the substrate W2. The attraction holes 42a to 42c are divided into a fourth group of attraction holes 42a, a fifth group of attraction holes 42b, and a sixth group of attraction holes 42c. The fourth to sixth group of attraction holes 42a to 42c are each connected to different tube lines. The suction force of the fourth to the sixth group of attraction holes 42a to 42c is adjusted by a valve (not shown) arranged in the corresponding tube line. The controller 16 controls the opening and closing of each valve.

In the first embodiment, the fourth group of attraction holes 42a is arranged at the central portion of the table 15. The fifth group of attraction holes 42b is arranged so as to surround the fourth group of attraction holes 42a. The sixth group of attraction holes 42c is arranged at the peripheral portion of the table 15. The fourth to the sixth group of attraction holes are arranged in a substantially concentric manner.

When the table 15 vacuum attracts the substrate W2, the controller 16 first supplies the vacuum pressure to the fourth group of attraction holes 42a to vacuum attract the central portion of the substrate W2. The controller 16 then supplies the vacuum pressure to the fifth group of attraction holes 42b to vacuum attract the intermediate portion of the substrate W2. Finally, the controller 16 supplies the vacuum pressure to the sixth group of attraction holes 42c to vacuum attract the peripheral portion of the substrate W2. The table 15 thus sequentially attracts the substrate W2 from the central portion towards the peripheral portion.

Such controlled vacuum attraction prevents the substrate W2 from deforming when the table 15 vacuum attracts the substrate W2. The deformation of the substrate W1 is corrected when the table 15 vacuum attracts the substrate W2 even if the substrate W2 is conveyed onto the table 15 in a deformed state.

The table 15 includes an electrostatic chuck that is similar to the electrostatic chuck of the pressing plate 20. The electrostatic chuck of the table 15 includes a number of electrostatic blocks b1 to b36 formed on the upper surface of the table 15. The controller 16 controls the application of voltage to the electrostatic blocks.

In the preferred embodiment, the four electrostatic blocks b1 to b4 arranged at the central portion of the table 15 are referred to as a central zone block group. The twelve electrostatic blocks b5 to b16 arranged so as to surround the electrostatic blocks b1 to b4 are referred to as an intermediate zone block group. The electrostatic blocks b17 to b36 arranged on the peripheral portion of the table 15 are referred to as a peripheral zone block group. The central zone block group, the intermediate zone block group, and the peripheral zone block group are arranged in a substantially concentric manner.

When the table 15 electrostatically attracts the substrate W2, the controller 16 first applies voltage to the electrostatic blocks b1 to b4 to electrostatically attract the central portion of the substrate W2. The controller 16 then applies voltage to the electrostatic blocks b5 to b16 to electrostatically attract the intermediate portion of the substrate W2. Finally, the controller 16 applies voltage to the electrostatic blocks b17 to b36 to electrostatically attract the peripheral portion of the substrate W2.

Such controlled electrostatic attraction prevents the substrate W2 from deforming when the table 15 electrostatically attracts the substrate W2. The deformation of the substrate W2 is corrected when switching from vacuum attraction to electrostatic attraction even if the substrate W2 is vacuum attracted to the table 15 in a deformed state.

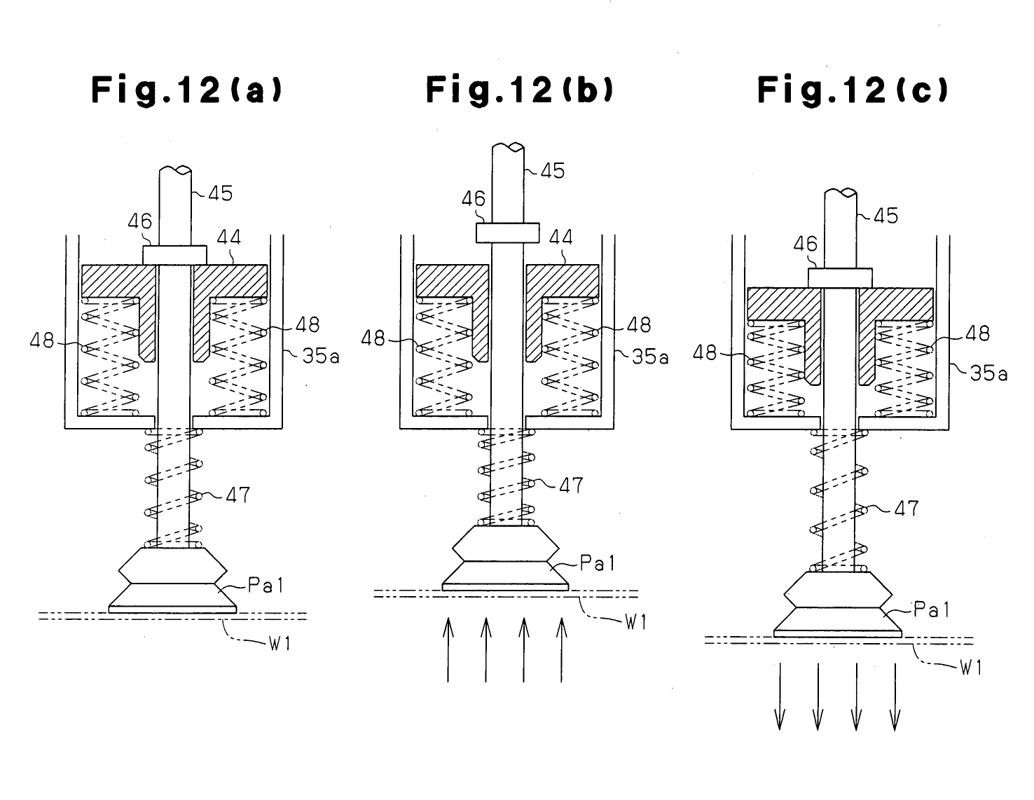

FIGS. 12 (a) to 12(c) show the attraction pad Pa1 of the upper holding device 23. The other attraction pads Pa2 to Pe9 and the attraction pads 32a to 32g of the first robot hand 28a also have the same structure.

In the support rod 35a, a contact member 44 is movably supported in the vertical direction, and an output tube 45 from where the vacuum pressure is supplied is inserted through the contact member 44. A flange 46 that comes into contact with the contact member 44 is formed on the output tube 45 in the support rod 35a. The attraction pad Pa1 is attached to the distal end of the output tube 45 outside the support rod 35a. The attraction pad Pa1 has an accordion configuration and is thus compressible and extendible.

A coil spring 47 is arranged between the attraction pad Pa1 and the support rod 35a. The coil spring 47 biases the attraction pad Pa1 away from the support rod 35a in the downward direction.

A plurality of coil springs 48 are arranged around the output tube 45 in the support rod 35a between the contact member 44 and the bottom of the support rod 35a. The coil springs 48 bias the contact member 44 in the upward direction when the gap between the contact member 44 and the bottom of the support rod 35a becomes equal to or less than a predetermined value.

When the upper holding device 23 receives the substrate W1 from the first robot hand 28a, a pressing force acts in the upward direction on the attraction pad Pa1, as shown in FIG. 12(b). In this state, the coil spring 47 is compressed and the attraction pad Pa1 is raised. When transferring the substrate W1 from the upper holding device 23 to the pressing plate 20, a tensile force acts in the downward direction on the attraction pad Pa1, as shown in FIG. 12(c). In this state, the coil spring 47 is extended and the coil springs 48 are compressed to lower the attraction pad Pa1.

Such compression and extension of the attraction pad Pa1 ensures the attraction and transfer of the substrate W1. Further, due to the accordion configuration of the attraction pad Pa1, the substrate W1 is stably attracted even if the substrate W1 is deformed or curved.

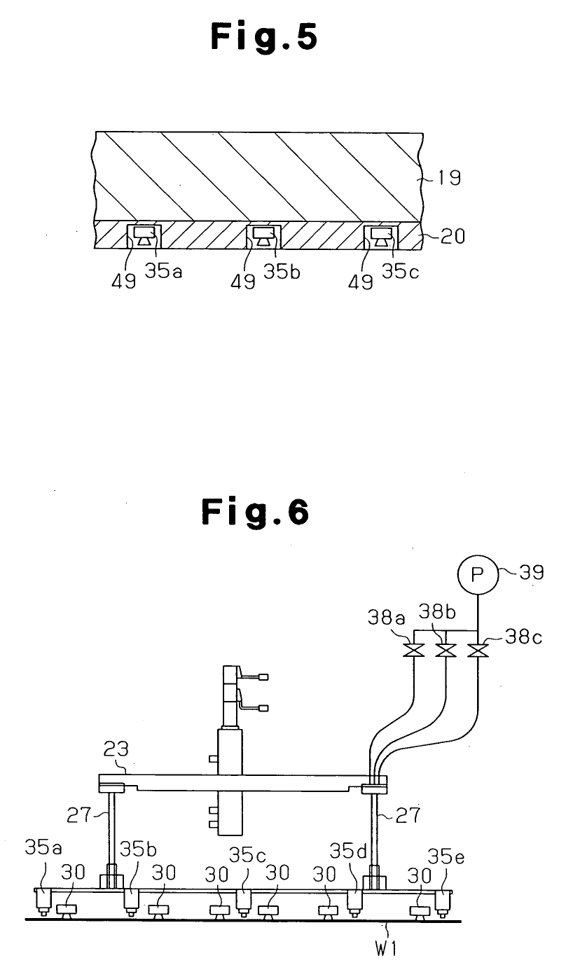

As shown in FIG. 5, accommodating grooves 49 are formed in the lower surface of the pressing plate 20 for each support rod 35a to 35e of the upper holding device 23 to accommodate the support rods 35a to 35e. When the upper holding device 23 is raised to the uppermost position, each support rod 35a to 35e is accommodated in the corresponding accommodating groove 49 so that the support rods 35a to 35e are not exposed or projected downward from the lower surface of the pressing plate 20.

The operation of the laminated substrate manufacturing apparatus will now be described with reference to FIGS. 13 to 24.

Prior to the transfer of the substrates W1 and W2, the substrate W1 is attracted to the first robot hand 28a, and the lower surface (non-laminating surface) of the substrate W2 is supported by the second robot hand 28b, as shown in FIG. 13. Further, a laminated substrate W3, which has been laminated in the previous cycle, is supported by the lower holding device 17.

From this state, the first robot hand 28a advances into the processing chamber (FIG. 14) and is then lowered (FIG. 15). In this state, the distal end of the upper arms 30 of the first robot hand 28a is supported by the deformation prevention piece 18 to correct the drooping of the upper arm 30 due to its weight.

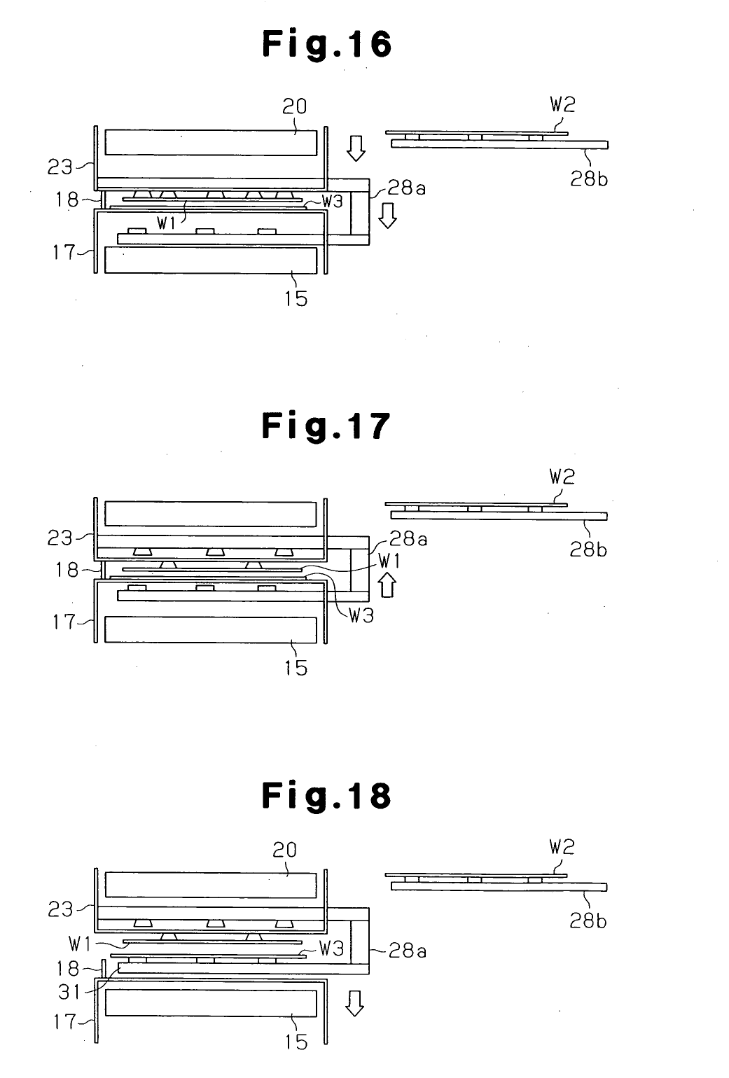

Then, the upper holding device 23 is lowered, and the substrate W1 is attracted to the upper holding device 23 (FIG. 16). The first robot hand 28a releases the substrate W1 and moves upward (FIG. 17). Then, the lower holding device 17 is lowered (FIG. 18). In this state, the substrate W3 is supported by the lower arms 31 of the first robot hand 28a.

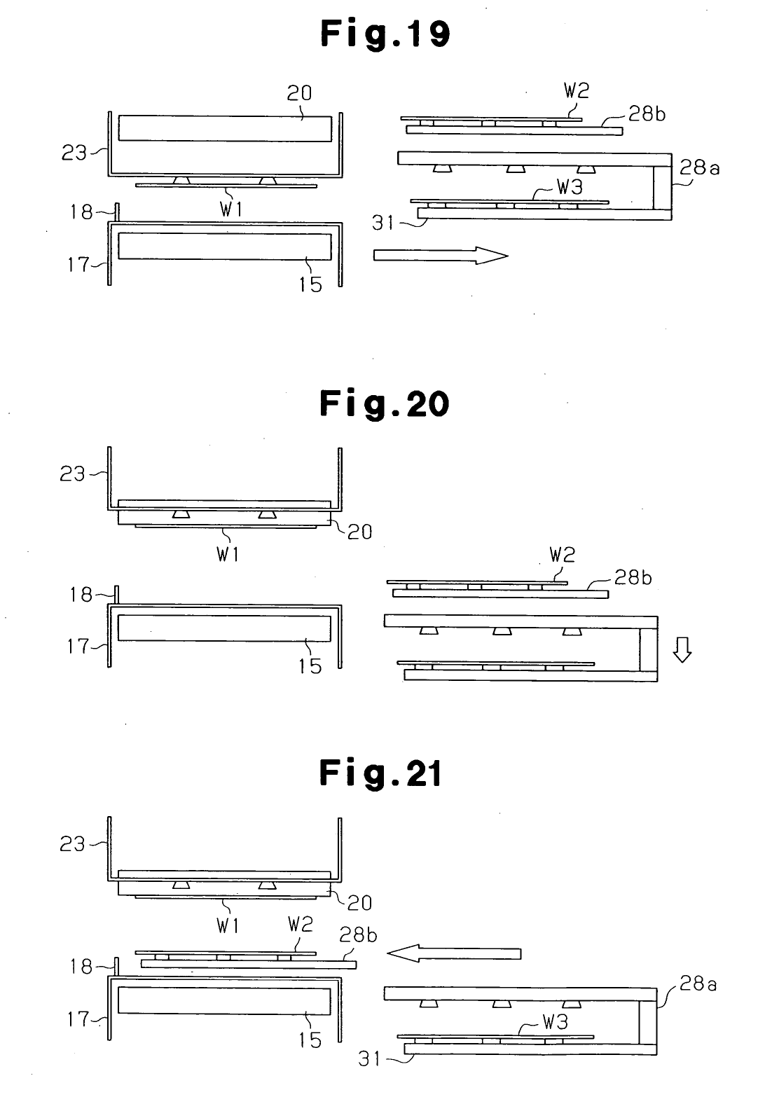

The first robot hand 28a then exits from the processing chamber (FIG. 19). Then, the upper holding device 23 is lifted. In a state contacting the lower surface of the pressing plate 20, the substrate W1 is vacuum attracted to the pressing plate 20 (FIG. 20).

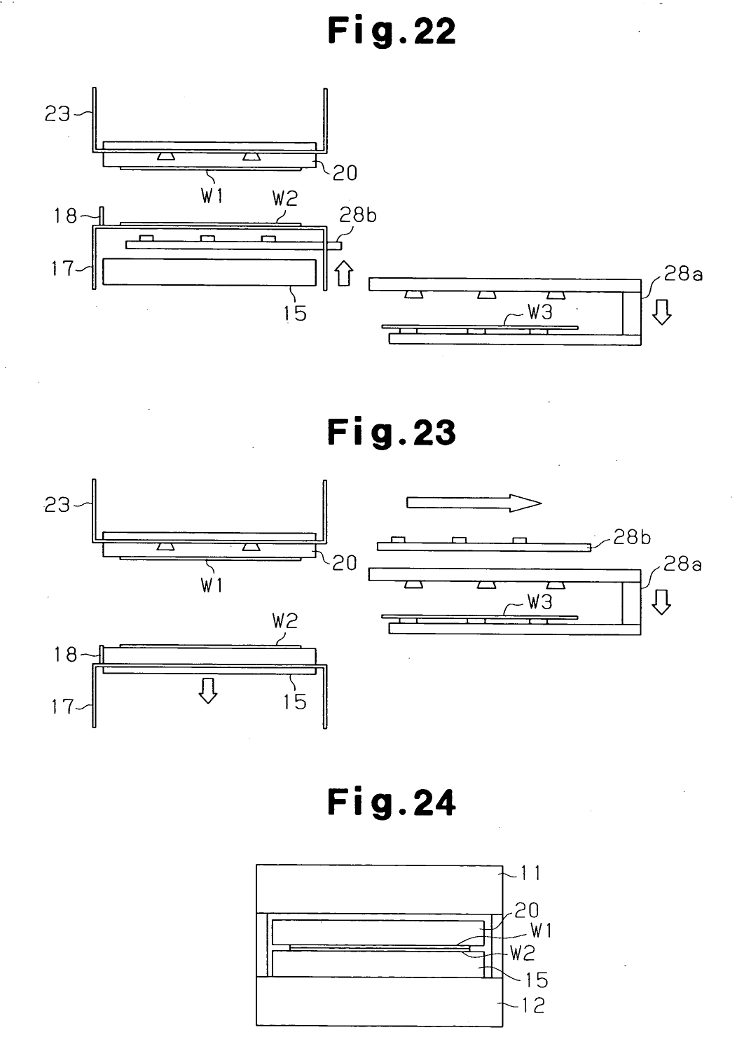

The second robot hand 28b then advances into the processing chamber (FIG. 21). The lower holding device 17 is then raised, and the substrate W2 is supported on the lower holding device 17 (FIG. 22).

The second robot hand 28b then exits the processing chamber, the lower holding device 17 is lowered, and the substrate W2 is supported on the table 15 in a state in which the lower surface of the substrate W2 is vacuum attracted to the table 15 (FIG. 23). The upper shell 11 and the lower shell 12 are then closed to seal the processing chamber. The substrates W1 and W2 are electrostatically attracted and the pressing process is performed in a vacuum environment (FIG. 24). During the pressing process, the two substrates W1 and W2 are aligned with each other by correcting their relative position with respect to each other in the horizontal direction within a certain range. The displacement in the horizontal direction of the pressing plate 20 and the upper holding device 23 is absorbed by the flexible couplings 26 during the alignment.

The laminated substrate manufacturing apparatus of the first embodiment has the advantages described below.

(1) When attracting the substrate W1 to the pressing plate 20, the upper holding device 23, which moves within the processing chamber, receives the substrate W1 from the first robot hand 28a, and then the pressing plate 20 receives the substrate W1 from the upper holding device 23. Thus, the shutter used in the prior art is unnecessary. This enables the laminated substrate manufacturing apparatus to be miniaturized and simplified.

(2) The upper holding device 23 attracts the upper surface of the substrate W1 and thus does not contact the lower surface (laminating surface) of the substrate W1. Further, the lower holding device 17 attracts the lower surface of the substrate W2 and thus does not contact the upper surface (laminating surface) of the substrate W2. Therefore, particles are not collected on the laminating surfaces.

(3) Since the shutter that enters the processing chamber from the exterior is unnecessary, particles are prevented from entering the processing chamber.

(4) The accommodating grooves 49 for accommodating the support rods 35a to 35e of the upper holding device 23 are formed in the lower surface of the pressing plate 20. Thus, the support rods 35a to 35e do not interfere with the attraction of the substrate W1 to the pressing plate 20.

(5) The flexible couplings 26 enable movement of the upper holding device 23 in the horizontal direction. This corrects displacements of the substrate W1 in the horizontal direction.

(6) The deformation prevention piece 18 is arranged on the lower holding device 17. Thus, when transferring the substrate W1 from the first robot hand 28a to the upper holding device 23, the upper arms 30 of the first robot hand 28a are prevented from drooping due to its weight. This further prevents deformation of the substrate W1.

(7) When the substrate W1 is attracted to the first robot hand 28a, the attraction pads at the middle of the upper arms 30 attract the substrate W1. Then, the attraction pads between the middle and the ends of the upper arm 30 attract the substrate W1. Finally, the attraction pads on both ends attract the substrate W1. Therefore, the substrate W1 is attracted to the upper arm 30 while correcting, or eliminating, the deformation of the substrate W1. Further, displacement of the substrate W1 during the attraction operation is prevented, and the substrate W1 is held in an ensured manner.

(8) When transferring the substrate W1 from the first robot hand 28a to the upper holding device 23, the support rods 35a to 35e of the upper holding device 23 sequentially vacuum attract the substrate W1 from the central portion towards the peripheral portion of the substrate W1. Therefore, the substrate W1 is prevented from deforming when the upper holding device 23 vacuum attracts the substrate W1.

(9) When transferring the substrate W1 from the upper holding device 23 to the pressing plate 20, the pressing plate 20 sequentially vacuum attracts the substrate W1 from the central portion towards the peripheral portion of the substrate W1. Therefore, the substrate W1 is prevented from deforming when the pressing plate 20 vacuum attracts the substrate W1.

(10) When attracting the substrate W1, which is vacuum attracted to the pressing plate 20, by switching to electrostatic attraction, the pressing plate 20 sequentially electrostatically attracts the substrate W1 from the central portion towards the peripheral portion of the substrate W1. Therefore, the substrate W1 is prevented from deforming when the pressing plate 20 electrostatically attracts the substrate W1.

(11) When vacuum attracting the substrate W2 to the table 15, the substrate W2 is sequentially vacuum attracted from the central portion towards the peripheral portion of the substrate W2. Therefore, the substrate W2 is prevented from deforming when the table 15 vacuum attracts the substrate W2.

(12) The deformation of the substrates W1 and W2 is eliminated between the conveying process and the attracting process of the substrates that are performed prior to lamination of the substrates W1 and W2. Thus, the substrates W1 and W2 are respectively attracted to the pressing plate 20 and the table 15 without being deformed. Therefore, a laminated substrate having high quality is manufactured with a high yield.

(13) The attraction pads arranged on the upper arms 30 of the first robot hand 28a and the support rods 35a to 35e of the upper holding device 23 are compressible and extendible with respect to the upper arm 30 or the support rods 35a to 35e. This ensures attraction of the substrate W1 even if the substrate is deformed or curved.

(14) The deformation prevention piece 18 is arranged on the lower holding device 17. Thus, the drooping of the upper arms 30 due to its own weight is prevented with the same driving source as that of the lower holding device 17.

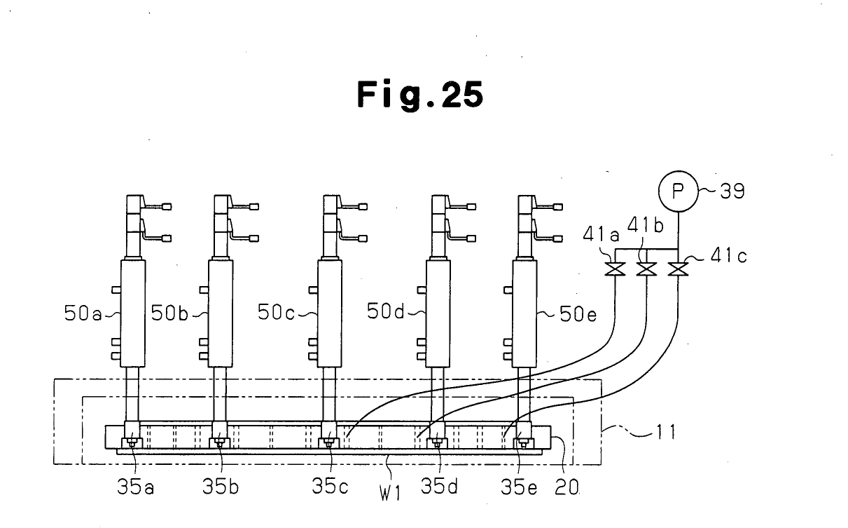

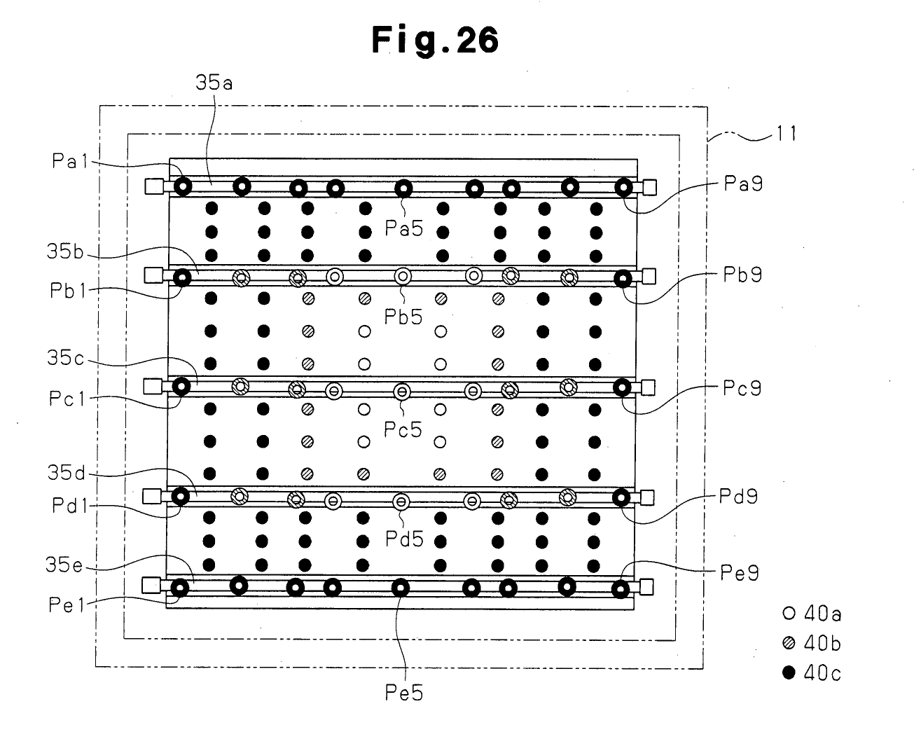

A laminated substrate manufacturing apparatus according to a second embodiment of the present invention will now be described with reference to FIG. 25 and FIG. 26. In the second embodiment, the support rods 35a to 35e of the upper holding device 23 are each independently lowered and raised. That is, each support rod 35a to 35e is lowered and raised by an independent lifting device 50a to 50e. The lifting devices 50a to 50e are each controlled by the controller 16. In the same manner, support rods of the lower holding device are each independently lowered and raised. The other parts are the same as in the first embodiment.

In the laminated substrate manufacturing apparatus of the second embodiment, when transferring the substrate W1 attracted to the upper holding device 23 to the pressing plate 20, the three support rods 35b to 35d at the central portion are slightly raised so that the central portion of the substrate W1 becomes higher than the peripheral portion. With the substrate W1 in such flexed state, the pressing plate 20 vacuum attracts the central portion of the substrate W1. Subsequent to the attraction by the first group of attraction holes 40a in the same manner as in the first embodiment, the second group of attraction holes 40b attracts the substrate W1. Then, the support rods 35a and 35e are raised. The third group of attraction holes 40c attracts the peripheral portion of the substrate W1 in this state.

When transferring the substrate W2 from the lower holding device 17 to the table 15, the support rods at the central portion are slightly lowered to attract the central portion of the substrate W2 to the table 15. The support rods on both sides are then lowered to attract the peripheral portion of the substrate W2 to the table 15.

The cooperation of the pressing plate 20 with the controlled operation of the support rods vacuum attracts the substrate W1 from the central portion towards the peripheral portion. The table 15 attracts the substrate W2 from the central portion towards the peripheral portion. Therefore, the second embodiment has the same advantages as the first embodiment.

It should be apparent to those skilled in the art that the present invention may be embodied in many other specific forms without departing from the spirit or scope of the invention. Particularly, it should be understood that the present invention may be embodied in the following forms.

When attracting the substrate W1 to the pressing plate 20, the substrate W1 may be sequentially attracted from the central portion towards the peripheral portion in at least either the vacuum attraction operation or the electrostatic attraction operation.

The deformation prevention piece 18 may be separate from the lower holding device 17.

The present examples and embodiments are to be considered as illustrative and not restrictive, and the invention is not to be limited to the details given herein, but may be modified within the scope and equivalence of the appended claims.

What is claimed is:

1. A manufacturing device for laminating substrates, each substrate including central and peripheral portions, the manufacturing device comprising:
a processing chamber;
holding plates, each arranged in the processing chamber, for respectively holding the substrates and laminating the substrates to each other;
an attraction device, arranged on at least one of the holding plates, for attracting a corresponding substrate; and
a controller for controlling the attraction device so that the attraction device sequentially attracts the corresponding substrate from the central portion to the peripheral portion.

2. The manufacturing device according to claim 1, wherein:
the substrates include an upper substrate and a lower substrate;
at least one of the holding plates is a pressing plate for holding the upper substrate; and
the attraction device of the at least one of the pressing plates includes attraction holes formed so as to face an upper surface of the upper substrate.

3. The manufacturing device according to claim 2, further comprising:
an upper holding device for conveying the upper substrate to the pressing plate; and
pads, arranged on the upper holding device, for vacuum attracting the upper surface of the upper substrate;
wherein the controller controls the pads so that the pads sequentially attract the upper substrate from the central portion to the peripheral portion.

4. The manufacturing device according to claim 3, wherein the upper holding device further includes:
support rods attached to the pads, the support rods including a first support rod for supporting at least the central portion of the upper substrate; and
lifting devices for respectively lowering and raising each of the support rods;
wherein the controller controls the lifting devices to raise the first support rod before attracting the upper substrate to the pressing plate.

5. The manufacturing device according to claim 1, wherein:
the substrate includes an upper substrate and a lower substrate;
at least one of the holding plates is a pressing plate for holding the upper substrate; and
the attraction device of the at least one of the pressing plates includes electrostatic chucks for electrostatically attracting an upper surface of the upper substrate.

6. The manufacturing device according to claim 5, further comprising:
an upper holding device for conveying the upper substrate to the pressing plate; and
pads, arranged on the upper holding device, for vacuum attracting the upper surface of the upper substrate;
wherein the controller controls the pads so that the pads sequentially attract the upper substrate from the central portion to the peripheral portion.

7. The manufacturing device according to claim 6, wherein the upper holding device further includes:
support rods attached to the pads, the support rods including a first support rod for supporting at least the central portion of the upper substrate; and
lifting devices for respectively lowering and raising the support rods;
wherein the controller controls the lifting devices to raise the first support rod before attracting the upper substrate to the pressing plate.

8. The manufacturing device according to claim 1, wherein:
the substrates include an upper substrate and a lower substrate;
at least one of the holding plates is a table for holding the lower substrate; and
the attraction device includes attraction holes, arranged in the table, for vacuum attracting a lower surface of the lower substrate.

9. The manufacturing device according to claim 1, wherein:
the substrate includes an upper substrate and a lower substrate;
at least one holding plate is a table for holding the lower substrate; and
the attraction device includes electrostatic blocks, arranged in the table, for electrostatically attracting a lower surface of the lower substrate.

10. The manufacturing device according to claim 1, further comprising:
a robot hand, including a distal portion, for conveying the substrates into the processing chamber; and
a deformation prevention device for correcting drooping of the distal portion of the robot hand due to its own weight.

11. The manufacturing device according to claim 1, wherein the substrate includes an upper substrate and a lower substrate, and at least one holding plate is a table for holding the lower substrate; the device further comprising:
a robot hand, including a distal portion, for conveying the substrates into the processing chamber;
a lower holding device for transferring the lower substrate from the robot hand to the table; and
a deformation prevention device, arranged on the lower holding device, for correcting the drooping of the distal portion of the robot hand due to its own weight.

12. The manufacturing device according to claim 1, wherein an attraction device is arranged on each holding plate, and the controller controls each attraction device so that the attraction device sequentially attracts the corresponding holding plate to the holding plate from the central portion to the peripheral portion.

13. The manufacturing device according to claim 12, wherein the controller controls each attraction device so that the attraction device sequentially attracts a corresponding substrate to the holding plate by attracting the corresponding substrate from the central portion to the peripheral portion in a substantially concentric manner.

14. The manufacturing device according to claim 1, wherein the substrates comprise an array substrate and a color filter substrate for a flat panel display panel.

15. A method for laminating substrates, each substrate including central and intermediate portions, with the intermediate portion located on the outer side of the central portion, and a peripheral portion located on the outer side of the intermediate portion, the method comprising:
attracting each substrate from the central portion to the intermediate portion and then the peripheral portion; and
laminating the attracted substrates.

16. The method according to claim 15, wherein said attracting includes attracting each substrate from the central portion to the intermediate portion and then the peripheral portion in a substantially concentric manner.

17. The method according to claim 15, wherein said attracting includes electrostatically attracting each substrate.

18. The method according to claim 15, wherein said attracting includes vacuum attracting each substrate.

19. The method according to claim 15, further comprising:
transferring each substrate from a robot hand to a holding device; and
transferring each substrate from the holding device to a holding plate;
wherein said attracting is performed when transferring each substrate from the robot hand to the holding device and when transferring each substrate from the holding device to the holding plate.
